(19) United States
(12) Patent Application Publication
(10) Pub. No.: US 2025/0131066 A1
(43) Pub. Date: Apr. 24, 2025

(54) SYSTEM AND METHOD FOR NAME CLASSIFICATION

(71) Applicants: Veronica Anne Beaupre, Windsor, CT (US); Xunchi Chen, Avon, CT (US); Cristina I. Gheorghe, Northbrook, IL (US); Hieu Quang Nguyen, Danbury, CT (US); Thomas J. Sibley, III, San Antonio, TX (US)

(72) Inventors: Veronica Anne Beaupre, Windsor, CT (US); Xunchi Chen, Avon, CT (US); Cristina I. Gheorghe, Northbrook, IL (US); Hieu Quang Nguyen, Danbury, CT (US); Thomas J. Sibley, III, San Antonio, TX (US)

(21) Appl. No.: 18/491,044

(22) Filed: Oct. 20, 2023

(51) Int. Cl. G06F 18/2415; G06F 18/2431

(52) U.S. Cl. CPC G06F 18/2415; G06F 18/2431

(57) ABSTRACT

According to some embodiments, systems and methods are provided, comprising a classification data store that contains electronic records associated with entity classifications; and the back-end application computer server, coupled to the classification data store, including: a computer processor; and a memory coupled to the computer processor and storing instructions that, when executed by the computer processor, cause the back-end application computer server to: receive a name and an address associated with the name; receive third-party data associated with the name; classify the name as an enterprise type using a classification tool and the third-party data, the classification tool including a trained hybrid machine learning (ML) model; a communication port coupled to the back-end application computer server to facilitate an exchange of data with a remote device via a distributed communication network to support interactive user interface displays that include information about the classification. Numerous other aspects are provided.

### TECHNICAL FIELD

The present application generally relates to computer systems and more particularly to computer systems that are adapted to accurately, securely, and/or automatically classify an entity name.

### BACKGROUND

An enterprise may interact with other entities in the operation of the enterprise. The enterprise may perform analyses of these entities and may classify the entities to assist in this analysis. The enterprise may use a Standard Industry Classification (SIC) code and/or North American Industry Classification System (NAICS) code for classifying activities of the entity. There may be over 1,000 class codes and the differences between the class codes may be subtle. As a non-exhaustive example, “Lawn Mower” vs “Landscaper” or “Children's Clothing” vs “Women's Clothing”. Conventionally, a user may manually select the code by performing a manual search of the class codes. With the extensive list of codes and subtle differences between codes, it may be difficult for an enterprise to accurately classify the entity. It may also be difficult to classify the entity in a timely manner.

It would be desirable to provide improved systems and methods to accurately and automatically predict a classification code for an entity. Moreover, the classification should be easy to access, understand, interpret, update, etc.

### SUMMARY OF THE INVENTION

According to some embodiments, systems, methods, apparatus, computer program code and means are provided to predict a classification for an entity based on the nature of the operations of that entity.

Some embodiments are directed to a system implemented via a back-end application computer server of an enterprise. The system comprises a back-end application computer server comprising: a classification data store that contains electronic records associated with entity classifications; and the back-end application computer server, coupled to the classification data store, including: a computer processor; and a memory coupled to the computer processor and storing instructions that, when executed by the computer processor, cause the back-end application computer server to: receive a name and an address associated with the name; receive third-party data associated with the name; classify the name as an enterprise type using a classification tool and the third-party data, the classification tool including a trained hybrid machine learning (ML) model; a communication port coupled to the back-end application computer server to facilitate an exchange of data with a remote device via a distributed communication network to support interactive user interface displays that include information about the classification.

Some embodiments are directed to a method implemented via a back-end application computer server of an enterprise. The method comprises receiving a name and an address associated with the name; receiving third-party data associated with the name; classifying the name as an enterprise type using a classification tool and the third-party data, the classification tool including a trained hybrid machine learning (ML) model; transmitting the classified enterprise type to a user and a client system; and displaying the classified enterprise type on a user interface display.

Other embodiments are directed to a non-statutory, computer-readable medium storing instructions that, when executed by a processor, cause the processor to perform a method implemented via a back-end application computer server of an enterprise. The method comprises receiving a name and an address associated with the name; receiving third-party data associated with the name; classifying the name as an enterprise type using a classification tool and the third-party data, the classification tool including a trained hybrid machine learning (ML) model; transmitting the classified enterprise type to a user and a client system; and displaying the classified enterprise type on a user interface display.

A technical effect of some embodiments of the invention is the improved and computerized entity classification generator for an enterprise that provides fast, accurate, secure and useful results.

With these and other advantages that will become hereinafter apparent, a more complete understanding of the nature of the invention can be obtained by referring to the following detailed description and to the drawings appended hereto.

### BRIEF DESCRIPTION OF THE DRAWINGS

FIG. 1 is a block diagram of a system architecture according to some embodiments.

FIG. 2 is a flow diagram according to some embodiments.

FIG. 3 is an outward view of a welcome page of a user interface display according to some embodiments.

FIG. 4 is an outward view of a classification message user interface according to some embodiments.

FIG. 5 is an outward view of a predicted classification user interface display according to some embodiments.

FIG. 6 is a flow diagram according to some embodiments.

FIG. 7 is a non-exhaustive example of a projection chart according to some embodiments.

FIG. 8 is a non-exhaustive example of centroids according to some embodiments.

FIG. 9 is an example of selecting prediction code according to some embodiments.

FIG. 10 is a block diagram of an apparatus according to some embodiments.

FIG. 11 is a block diagram of a system according to some embodiments.

FIG. 12 illustrates a tablet computer displaying a classification display user interface according to some embodiments.

Throughout the drawings and the detailed description, unless otherwise described, the same drawing reference numerals will be understood to refer to the same elements, features and structures. The relative size and depiction of these elements may be exaggerated or adjusted for clarity, illustration, and/or convenience.

### DETAILED DESCRIPTION

The following description is provided to enable any person in the art to make and use the described embodiments and sets forth the best mode contemplated for carrying out some embodiments. Various modifications, however, will remain readily apparent to those in the art.

One or more embodiments or elements thereof can be implemented in the form of a computer program product including a non-transitory computer readable storage medium with computer usable program code for performing the method steps indicated herein. Furthermore, one or more embodiments or elements thereof can be implemented in the form of a system (or apparatus) including a memory, and at least one processor that is coupled to the memory and operative to perform exemplary method steps. Yet further, in another aspect, one or more embodiments or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

The present invention provides significant technical improvements to facilitate data processing associated with generating a classification for an entity. The present invention is directed to more than merely a computer implementation of a routine or conventional activity previously known in the industry as it provides a specific advancement in the area of electronic record analysis by providing improvements in the operation of a computer system that classifies operations of an entity based on an entity name and address. The classification may be used for further analysis. Non-exhaustive examples of further analysis may include risk and underwriting concerns of an insurance policy (e.g., quoting steps and pricing calculations), or for use in detecting entities that are mis-classified. Pursuant to some embodiments, the classification may be pre-filled into another system (e.g., an agent-facing frontend quoting system, an automated quote Application Programming Interface (API), etc.) in a case the classification model's confidence in the classification meets a given threshold value or in a case the classification is the top predicted classification. Pre-filling may be an automatic classification process whereby a Machine Learning (ML) model directly assigns the top predicted internal classification code to an entity if a confidence value for that prediction is at least 0.7. It is noted that this threshold of 0.7 has been shown to capture a third of input entity names with an accuracy of 68%, meaning that for one-third of the cases, a user may rely on the model's top prediction without needing to reassess or alter it, saving considerable time and resources. The classification model may also present several classification predictions as suggestions for selection by a user. If the ML model's confidence score is lower—falling between 0.5 and 0.7, for example—the ML model may present the top seven (or other suitable number) of predictions to the user as suggestions. With this suggestion approach, it is noted that another 40% of the input entity names are captured with an accuracy of 69%, empowering a user to select the most suitable internal classification code from a narrowed down, model-provided selection, combining machine intelligence with human judgement to provide a more accurate selection. As described above the accuracy of the selection may have trickle down effects in other systems. The present invention provides improvement beyond a mere generic computer implementation as it involves the novel ordered combination of system elements and processes to provide improvements in the speed, security, and accuracy of such a classification tool for an enterprise. Some embodiments of the present invention are directed to a system adapted to automatically classify operations of an entity using two classification processes, aggregate the data, and output a final classification including a confidence score for the classification, automatically optimize information to reduce unnecessary messages or communications, etc. (e.g., to consolidate classification data). Moreover, communication links and messages may be automatically established, aggregated, formatted, modified, removed, exchanged, etc. to improve network performance (e.g., by reducing an amount of network messaging bandwidth and/or storage required to create classification messages or alerts, improve security, reduce the size of a classification data store, more efficiently collect data, etc.).

Embodiments provide a classification generator system (“classification tool”) to use an entity name and third-party data to predict a classification code for the operations of the entity. It is noted that while the examples described herein are described with respect to classifying the operation of the entity, embodiments may be applicable to other classifications (e.g., user interactions, preferences, demographic data, etc.). Conventional classification models may have thousands of variables that are searched for in literal strings in entity name and third-party sources. As such, conventional classification models may be computationally intensive to run, and therefore also time-consuming to re-train when new classifications are added. Further, users may have strict model run time requirements, such that the model may provide the prediction on limited resources within a very short time. It may also be challenging to add new information (e.g., first party or third party sources) without hitting computational limits, as well as adding new class codes that do not have historical data associated therewith for training the model. Another challenge with conventional classification models that analyze the entity name and third-party sources for literal text strings is that the model then does not pick up on important context and other information that may provide a more accurate classification. Conventional classification models may include over a thousand possible class codes, and the distribution of entity class code assignments may be imbalanced, making it challenging for a traditional multi-class regression model to provide an accurate classification prediction.

Pursuant to embodiments, the classification tool combines a supervised machine learning model and an unsupervised machine learning model to accurately classify entities into specific internal classification codes. As further described below, the supervised machine learning model relies on labelled input and output training data. In particular, the supervised machine learning model may use a K-Nearest Neighbors (KNN) classifier and text embeddings to classify entities based on their proximity to other entities in a multi-dimensional feature space. As a non-exhaustive example, the supervised machine learning model may output three top predicted classification codes for an entity. The unsupervised machine learning model processes unlabeled/raw data. In particular, the unsupervised machine learning model may use a classification approach based on class centroids that generates additional predicted classification codes for the entity by comparing the entity to centroids created from, as a non-exhaustive example, the top 25 most common words for each class code. The classification tool may then combine both sets of predicted classification codes, and output one or more predicted classifications to a user and/or other system. The hybrid approach of combining the supervised and unsupervised machine learning models provides for a more accurate prediction of class codes for an entity as compared to conventional approaches that do not use both supervised and unsupervised machine learning models.

Embodiments provide for a classification tool that is predictively reliable, with a reduction in false positive rates as compared to conventional classification models. The classification tool provided by embodiments also provides for the integration of new class codes without requiring extensive historical datasets for training (e.g., some representative data is still used to ensure accurate classifications for these new codes), making the classification tool easily adapt to changing enterprise dynamics. Further, the classification tool may, according to one or more embodiments, directly map an internal classification code to an external classification code, providing enhanced efficiency in data handling. This efficiency may reduce the time used to generate a classification, which may enhance the user experience and may reduce the load on other systems that would otherwise execute further classification processes. It is further noted that the incorporation of enterprise rules by the classification tool may provide a tool that is not solely data-driven but also incorporates entity insights, making the classification tool more applicable to real-world contexts. The machine learning operations framework of embodiments provides for model updates and refinements to be quickly introduced into the operational environment, ensuring users always have access to the most updated and refined predictions. According to one or more embodiments, the classification tool may also include a tracking model to track and classify changes in rules or operations of the entity. As a non-exhaustive example, the tracking model may detect if an entity that was first classified as a café has now morphed into a nightclub, resulting in a different classification. In this non-exhaustive example, the change may be important to an insurance company, for example, as different risk assessments and policy features are applicable to a café versus a nightclub.

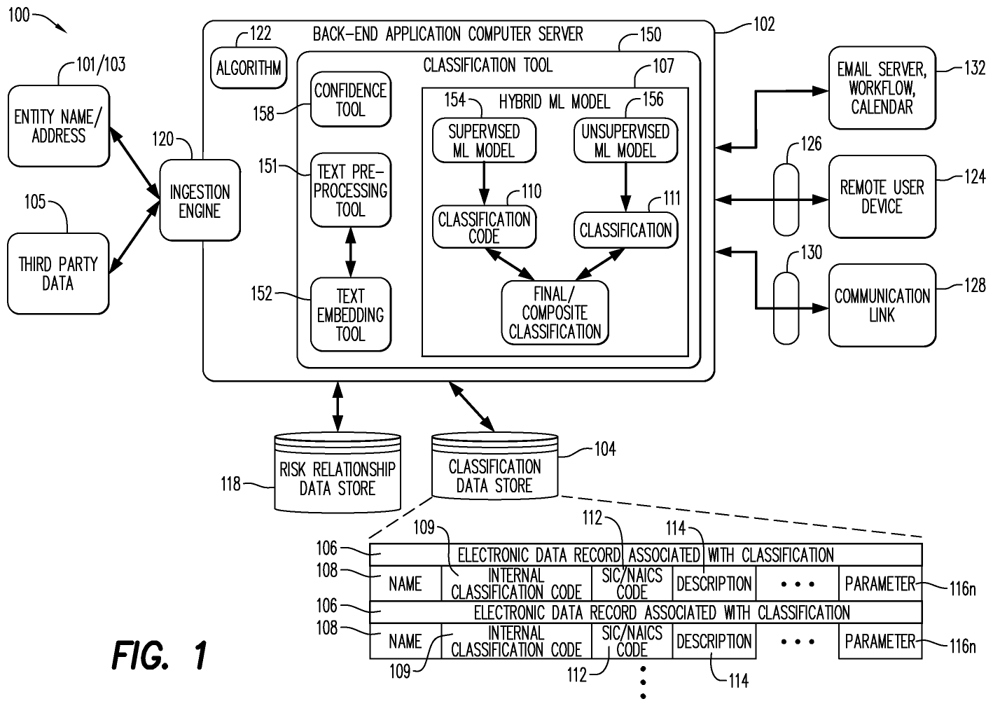

FIG. 1 is a high-level block diagram of a classification generator system 100 that may be provided according to some embodiments of the present invention. In particular, the system 100 includes a back-end application computer server 102 that may access information in a classification data store 104 (e.g., storing a set of electronic records associated with classification codes, each record 106 including, for example, a name 108, an internal classification code 109, an external (SIC/NAICS) classification code 112, a description 114, other parameters 116n. The back-end application computer server 102 may also store information into other data stores, such as a risk relationship data store 118, and may utilize an ingestion engine 120 and algorithm 122 to exchange and process messages (e.g., on-demand changes, requests for predictions and/or new class codes) and view, analyze and/or update the electronic records. The back-end application computer server 102 may also exchange information with a remote user device 124 (e.g., via a firewall 126). The back-end application computer server 102 may also exchange information via communication links 128 (e.g., via communication port 130 that may include a firewall) to communicate with different systems. The back-end application computer server 102 may also transmit information directly to an email server, workflow application, and/or calendar application 132 to facilitate automated communications and/or other actions. According to some embodiments, an interactive graphical user interface platform of the back-end application computer server 102 may facilitate resource management, schedule recommendations, alerts, and/or the display of results via one or more remote administrator computers (e.g., to display the predictions) and/or the remote user device 124. For example, the remote user device 124 may transmit a new classification code and/or a new entity for classification and/or updated information regarding a class description to the back-end application computer server 102. Based on the updated information, the back-end application computer server 102 may adjust data in the classification data store 104, and the change may (or may not) be used in connection with other systems. Note that the back-end application computer server 102 and/or any of the other devices and methods described herein might be associated with a third party, such as a vendor that performs a service for an enterprise.

The back-end application computer server 102 may also include a classification tool 150. The classification tool 150 may include a text pre-processing tool 151, a text embedding tool 152, a hybrid model 107 (including a supervised machine learning (ML) model 154, an unsupervised machine learning (ML) model 156) and a confidence tool 158.

The text pre-processing tool 151 may process any received entity name (and other suitable received input) with several steps. The text pre-processing tool 151 may first fill non-available (NA) spaces. For example, the text pre-processing tool 151 may replace any missing values (NAs) within the dataset (e.g., entity name) with empty strings. Ensuring no null values exist may avoid potential errors during subsequent steps and may provide for uniform processing of the records. The text pre-processing tool 151 may also remove punctuation marks (e.g., commas, periods, exclamation marks, etc.) from the entity name, as punctuation marks may clutter the data without adding semantic meaning. Additionally, the text pre-processing tool 151 may remove stop words (e.g., “and”, “the”, “is”, etc.) which may be redundant and frequent, and therefore may skew the analysis of the other words in the entity name. Abbreviations may also be replaced (e.g., “Dr.” to “Doctor”) by the text pre-processing tool 151 to provide uniformity of the terms analyzed by the text embedding tool 152. The text pre-processing tool 151 may also execute a lemmatization process whereby a word may also be converted to its base or root form (e.g., “running” is converted to “run”), thereby reducing dimensionality. The lemmatization process may also enhance the performance of the text embedding tool 152 by combining different forms of a word to a common base form, creating greater uniformity. The text pre-processing tool 151 may remove non-English words from the entity name, as the non-English words may add noise and unpredictability to the classification. It is noted that removal of the non-“English” words is a non-exhaustive example, and the classification tool 150 may be used with other languages, and remove terms not in those other languages. Repeated occurrences of a same word within a text record may also be removed by the text pre-processing tool 151, as the duplicated words may bias the classification tool 150 towards certain patterns. The text pre-processing tool 151 may also remove extra white spaces between words, such that multiple white spaces between words are reduced to a single space.

The text embedding tool 152 may convert pre-processed text (e.g., name of the entity) output by the text pre-processing tool 151, as described above, into a numerical vector that the can be used by the ML models. The text embedding tool 152 may employ shallow neural networks to create a vector space (e.g., several hundred dimensions) from a large corpus of text. Each unique word in the corpus may be assigned a corresponding vector in the space. Pursuant to some embodiments, the text embedding tool 152 may use a pre-trained model for text processing. The pre-trained model may have been trained on a wide variety of web text, allowing the model to capture a rich set of semantic and syntactic relationships. It is noted that using a model trained on a wide variety may be beneficial as the model may apply context to the terms found in the entity name. Pursuant to embodiments, the pre-processed entity names combined with third-party data attributes, as described further below, may be considered a corpus of text, where each unique word represents a potential attribute of the entity. With each unique word as input, the text embedding tool 152 generates an embedded representation for each word, encoding its contextual relevance with other words in the corpus. As a non-exhaustive example, “chicken” is closer to “pig” than it is to “tree”. The input to the text embedding tool 152 is converted to a 300-dimension vector, with each dimensional space representing an embedded linguistic meaning of the word. Other suitable dimension-sized vectors may be output from the text embedding tool 152. The vector may be the input to the ML models, as described further below.

The supervised machine learning (ML) model 154 may be a K-Nearest Neighbors (KNN) algorithm that operates on the concept of feature similarity to make predictions. The supervised ML model 154 may be non-parametric such that it makes no explicit assumptions about the functional form of the data. Each entity (e.g., data point) is represented in the form of a multi-dimensional feature vector, with each dimension corresponding to a feature. The features may include the text embedding tool 152 embeddings of words in the entity name, as well as other third-party data attributes. The supervised ML model 154 may output a list of one or more predicted internal classification codes 110, in order of decreasing likelihood of the predicted internal class code being accurate. According to some embodiments, the list may include the most likely top three predicted internal classification codes. The use of the KNN algorithm may provide a “localized” strategy by analyzing the nearest neighbors, while giving little concern to the overall class code distribution (as considered by conventional class code predictors). The use of the KNN algorithm may provide comparable accuracy on the largest class code at much lower false positive rates as compared to conventional class code predictors, resulting in significantly higher accuracy on the smaller class codes. This may provide for a higher overall accuracy without sacrificing statistical measures, and also provide a more diverse set of accurate classification code predictions.

The unsupervised machine learning (ML) model 156 may generate, using cosine similarity, as further described below, additional predicted internal class codes 111 for the given entity name to supplement the output of the supervised ML model 154. It may be desirable to supplement the output of the supervised ML model 154, to provide a more comprehensive prediction set.

The confidence tool 158 may generate a confidence score for each predicted internal classification code 110,111. The confidence score/value indicates how sure the confidence tool 158 is that the respective intent/prediction of the ML model 154/156 is correctly assigned (e.g., how strongly the model associates each prediction with a test item). The higher the confidence score, the higher the model's confidence that the predicted value should be applied to the entity name. The confidence score provides for the classification tool 150 to list the predicted internal classification codes in descending likelihood of being an accurate code to describe the operation of the entity. Pursuant to embodiments, the confidence score may be confined to [0, 1], where larger values may mean the ML models are more confident that the prediction is accurate. Other values for confining the confidence score may be used. The confidence score may be calculated for any possible classification code. In embodiments, the sum of all confidence scores for all internal class codes is equal to 1. For example, for the entity “Peter's Pizza Tavern,” one internal classification code (restaurant) has a confidence score of 0.7 and another internal classification code (bar) of 0.3. The confidence score may be constructed based on the type of ML model (supervised vs. unsupervised), as described further below.

The back-end application computer server 102 and/or the other elements of the system 100 may be, for example, associated with a Personal Computer (“PC”), laptop computer, smartphone, an enterprise server, a server farm, and/or a database or similar storage devices. According to some embodiments, an “automated” back-end application computer server 102 (and/or other elements of the system 100) may facilitate the automated access and/or update of electronic records in the data stores 104, 118 and/or the management of resources. As used herein, the term “automated” may refer to, for example, actions that can be performed with little (or no) intervention by a human.

Devices, including those associated with the back-end application computer server 102 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The back-end application computer server 102 may store information into and/or retrieve information from the classification data store 104, and/or the risk relationship data store 118. The data stores 104, 118 may be locally stored or reside remote from the back-end application computer server 102. As will be described further below, the classification data store 104 may be used by the back-end application computer server 102 in connection with an interactive user interface to access and update electronic records. Although a single back-end application computer server 102 is shown in FIG. 1, any number of such devices may be included. Moreover, various devices described herein might be combined according to embodiments of the present invention. For example, in some embodiments, the back-end application computer server 102 and classification data store 104 may be co-located and/or may comprise a single apparatus.

The elements of the system 100 may work together to perform the various embodiments of the present invention. Note that the system 100 of FIG. 1 is provided only as an example, and embodiments may be associated with additional elements or components. According to some embodiments, the elements of the system 100 automatically transmit information associated with an interactive user interface display over a distributed communication network. User interfaces 300, 400, 500, 1210, etc. may be presented on any type of display apparatus (e.g., desktop monitor, smartphone display, tablet display) provided by any type of client device (e.g., desktop system, smartphone, tablet computer). The application, which is executed to provide user interface 300, 400, 500, 1210, etc., may comprise a Web Browser, a standalone application, or any other application. Embodiments are not limited to user interface 300, 400, 500, 1210, etc.

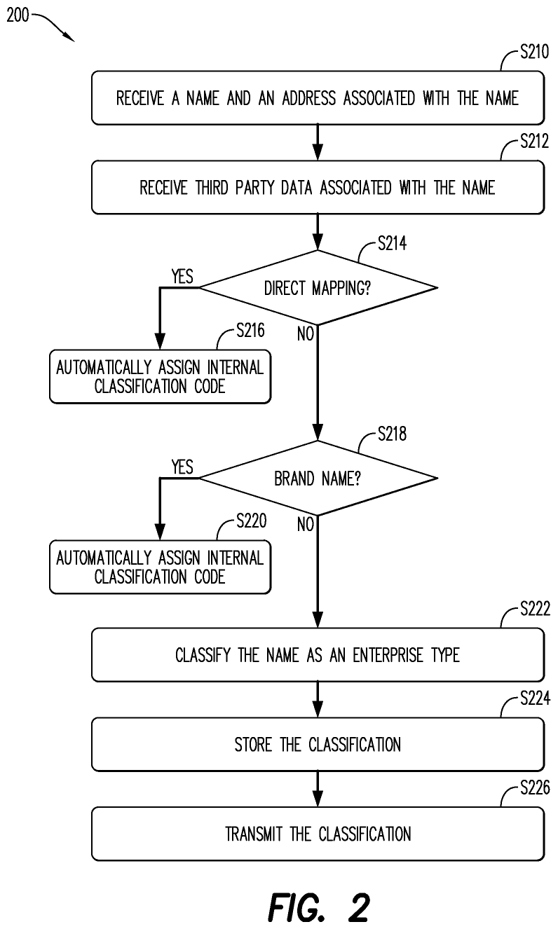

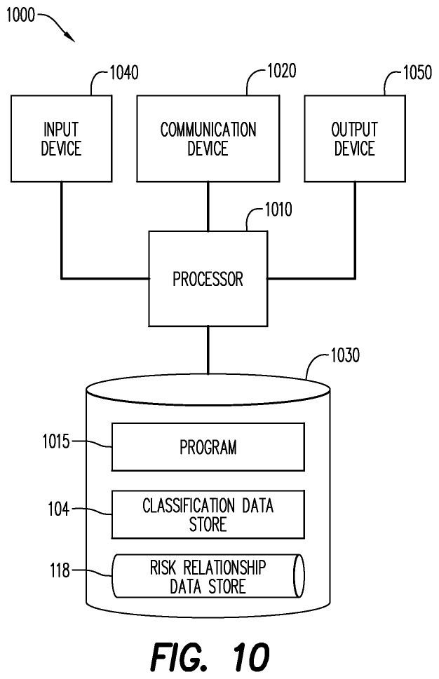

FIG. 2 illustrates a method 200 that might be performed by some or all of the elements of the system 100 described with respect to FIG. 1, or any other system, according to some embodiments of the present invention. In one or more embodiments, the back-end application computer server 102 may be conditioned to perform the process 200 and any other processes described herein, such that a processor 1010 (FIG. 10) of the server 102/system 100 is a special purpose element configured to perform operations not performable by a general-purpose computer or device. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein. The instructions may be embodied in processor-executable program code read from one or more of non-transitory computer-readable media, such as a hard drive, a floppy disk, a CD-ROM, a DVD-ROM, a Flash drive, Flash memory, a magnetic tape, and solid state Random Access Memory (RAM) or Read Only Memory (ROM) storage units, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

Prior to the method 200, a training data set is created and stored as a plurality of records 106 in the classification data store 104. The training data set maps the entity name to an internal classification code, and includes a description of the class including one or more keywords.

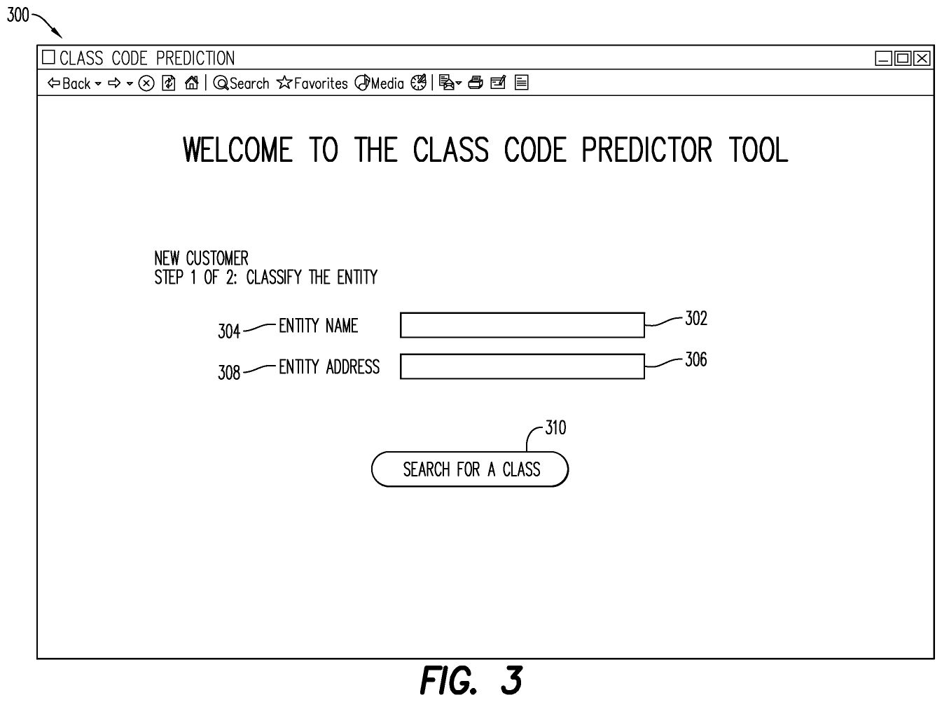

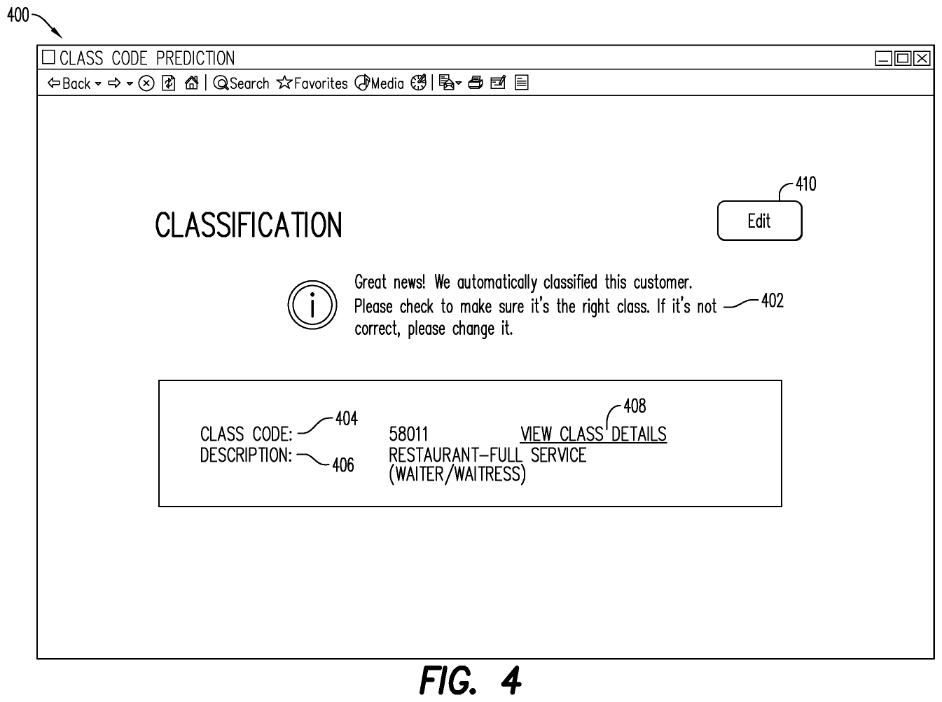

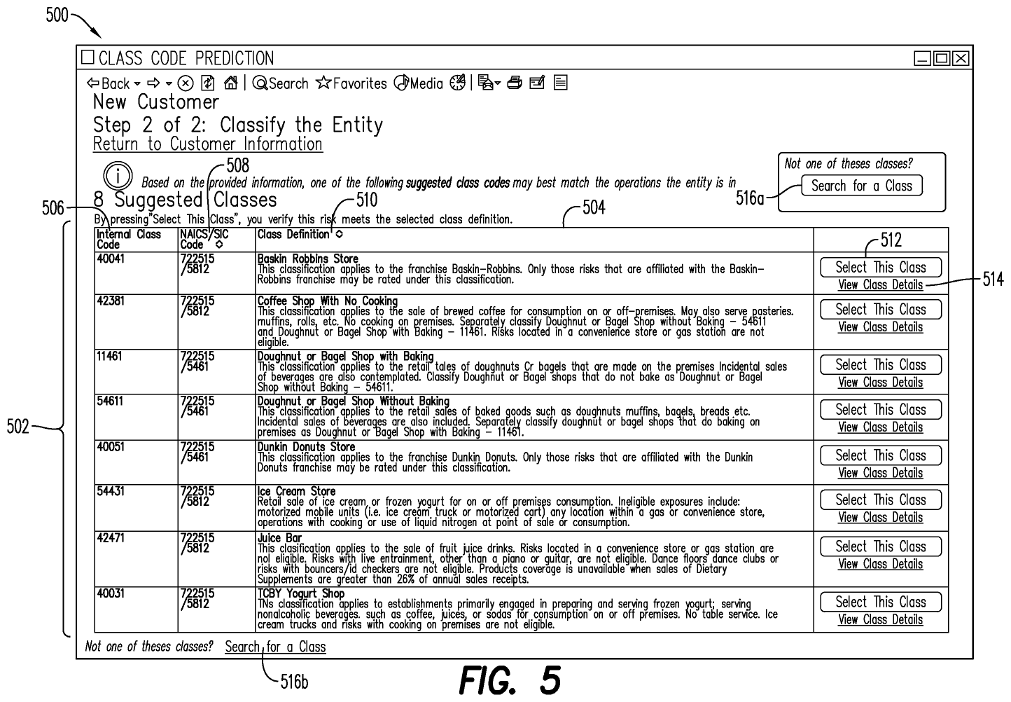

Additionally, and also prior to the method 200, a user may access the classification tool 150 and be provided with a welcome dashboard display 300 in accordance with some embodiments as described below with respect to FIG. 3. The welcome dashboard display 300 may include an entity name user entry field 302 for the entity name parameter 304 and an address user entry field 306 for the address parameter 308. The welcome dashboard display 300 may also include navigation icons 310. Selection of various icons (e.g., via a touch screen or computer mouse pointer or keyboard), such as the “search for a class” icon 310, may result in the display of a subsequent user interface as described in connection with FIGS. 4-5.

Initially at S210, a value for an entity name 101 is received in the name user entry field 302. The entity name 101 may be received at the classification tool 150 via the ingestion engine 120. The entity name 101 may be the business legal name for the entity or the “doing business as” (DBA) name for the entity, also referred to as a “trade name”. A value for an address 103 for the entity may also be received in the address user entry field 306 at S210. The entity name 101 and the address 103 may be input by a user. The user may then select the “Search for a Class” icon 310. In response to selection of the “Search for a Class” icon 310, third party data 105 associated with the entity name 101 is received at S212. The third party data may be received using the entity name and address as a search key. The third party data may be received at the classification tool 150 via the ingestion engine 120. The third-party data may be used to increase classification code prediction accuracy. Non-exhaustive examples of third party data include “Carpe data classification tags” from Minerva®. The carpe data classification tags may be a list of key words and phrase that describe operations of the entity. Another non-exhaustive example of third party data includes primary NAICS codes from Experian Commercial Risk Database Plus®. Yet another non-exhaustive example of third party data includes primary NAICS codes and the “line of business” description from the Worldbase file from Dun & Bradstreet®. Pursuant to some embodiments, a user may provide a SIC or NAICS code instead of those codes being provided by a third party data source.

In some embodiments, also in response to selection of the “Search for Class” icon 310, the received entity name and address may be transmitted to an artificial intelligence (AI) natural large language model (LLM) (e.g., ChatGPT®) with a prompt to request keywords or short phrases that describe the entity's primary operations. Safeguards may be in place to ensure only the entity name and address are sent to the AI natural LLM. The AI natural LLM may generate new content based on the input. The AI natural LLM may execute a number of text-processing tasks, such as receiving a small amount of input text to generate relevant machine-generated text. As a non-exhaustive example, the prompt may be “Please generate 5 keywords to describe the operation of R. Marthius LLC, located at 240 N. Medical Park Dr., Columbus, SC 29303.” The AI language processing model may then return the relevant keywords. Continuing with our non-exhaustive example, the AI language processing model may return “dentist”, “general practice”, “dental”, “oral healthcare”, and “multi-specialty group”. Pursuant to some embodiments, after the relevant keywords are received from the AI natural language processing model, they may be presented to the user, via a display (not shown), for validation. This validation step may prevent possible “hallucination” (e.g., false information or facts) generated by the AI natural LLM. The validated key words may also be received by the classification tool 150 in S212.

In S214 a direct mapping status is determined. Direct mapping indicates a valid mapping exists from an external classification code (e.g., SIC/NAICS codes from third party data) to the internal classification code. The third party data associated with the entity name may include an external classification code that has previously been mapped to a particular internal classification code prior to execution of the method 200. This may occur in a case the entity name is not new to the system. As a non-exhaustive example, the entity name may be Baskin Robbins®. There may be different addresses (locations) of the Baskin Robbins®, but the entity name is known to the system and as such, the external classification code for Baskin Robbins may have already been mapped to an internal classification code. As another non-exhaustive example, “Subway®” may have a direct mapping to “Fast Food Restaurant”. In a case it is determined the direct mapping status is that direct mapping exists, the internal classification code is automatically assigned to the entity in S216. In response to the automatic assignment per the direct mapping, a classification user interface display 400 (FIG. 4) may be provided to the user. The classification user interface display 400 may include a classification message 402 indicating the entity has been mapped to an internal classification code. The classification user interface display 400 may also include an internal classification code 404 and a classification code description 406. Pursuant to some embodiments, the classification user interface display 400 may also include a link 408 to view further details about the assigned classification code. It is noted that limiting the data presented on the user interface improves network performance (e.g., by reducing an amount of network messaging bandwidth and/or storage required to transmit the classification data). The classification user interface display 400 may also include an “Edit” icon 410. Selection of the “Edit” icon 410 allows a user to manually override the automatically selected internal classification code.

In a case it is determined the direct mapping status is that the direct mapping is absent, it is determined whether the entity name is a brand name at S218. Brand names (e.g., “Dunkin'®” or “Subway®”) may have no inherent semantic meaning, and the embeddings may not accurately reflect their operations. With the “Subway®” example, it may not necessarily associate closely with fast-food restaurants in a semantic vector space, and may more closely associated with transportation. To address this, the classification data store 104 may include a brand name list including brand names mapped to internal classification codes. The classification tool 150 may automatically, upon receipt of the entity name, compare the input entity name to the brand name list. In a case it is determined at S218 the entity name is a brand name, the classification tool 150 may automatically assign the stored internal classification code in S220.

In a case it is determined at S218 that the entity name is not a brand name, a trained hybrid machine learning model 107 may classify the entity name 101 using the third party data 105 in S222. The trained hybrid machine learning model 107 may include a supervised ML model 154 utilizing a KNN classifier and an unsupervised ML model 156. As described further below, the supervised ML model 154 uses text embeddings of the entity name and other attributes (e.g., third-party provided external codes and their respective descriptions) to generate one or more top predicted internal classification codes based on the predicted internal classification codes semantic closeness to existing entity names. As also described further below, the unsupervised ML model 156 generates additional predicted internal classification codes by comparing the entity name to class centroids generated from the top twenty five most common words for each internal classification code.

It is noted that some entity names may fall into pairs of internal classification codes that are very similar, with one being a Lessor Risk Only (LRO) code and the other a regular distribution code. A non-exhaustive example may be “Building—Lessor Risk Only” and “Building—Construction.” In cases where the top prediction is a member of such a pair, both potential internal classification codes are output, thereby providing a more accurate representation of the possibilities for the entity (e.g., risk and distribution possibilities).

The predictions from each of the supervised ML model 154 and the unsupervised ML model 156 may be blended to provide a predicted set of internal classification codes.

FIG. 5 is a predicted classification codes user interface display 500 (FIG. 5). The predicted classification codes user interface display 500 includes a predicted set 502 of internal classification codes. The predicted classification codes user interface display 500 may include a table 504 of suggested classification codes. The table 504 may include an internal classification code 506, and for each internal classification code 506, an external classification code 508 (NAICS/SIC code), and a class definition 510. The table 504 may also include a “Select the Class” icon 512 for selecting the internal classification code to map to the received entity name, as described further below. The table may also include a “View Class Details” link 514. Selection of the “View Class Details” link 514 may present the user with another display that includes further classification details. The predicted classification codes user interface display 500 may also include a “Search for a class” icon 516a and link 516b. Selection of either of the icon 516a and the link 516b may present the user with another display that may provide for additional searching.

A single internal classification code may be selected from the predicted set. The selection may be manually selected by a user or may be automatically selected by the classification tool 150 based on a confidence value output from a confidence tool 158, as described further below. The predicted set 502 may include both in-appetite and out-of-appetite classification codes in a case the enterprise executing the method is an insurance company. Appetite may refer to “risk appetite,” which is the maximum amount of risk an undertaking is willing to accept in order to achieve its strategic objectives.

Pursuant to some embodiments, an entity name may be classified as a “Loosely Defined Business” (LBD) in a case there is not enough data to assign a specific internal classification code with a particular level of confidence (confidence value). It is noted that an entity name may also be classified as LBD in a case the classification model 150 assigns a low confidence value to the predicted internal classification code.

Then, in S224, the selected internal classification code mapped to the entity name may be stored in the classification data store 104. The selected internal classification code may be transmitted in S226 to at least one of a user interface display or another system.

In a case the method 200 includes execution of the AI natural LLM to generate keywords, after the predicted set of internal classification codes is provided, the method 200 may be executed without execution of the AI natural LLM to generate a predicted set of internal classification codes. Then the predicted set of internal classification codes taking the keywords into account and the predicted set of internal classification codes that do not take the keywords into account may be compared to measure a value of using the AI natural LLM. It is noted that the use of the AI natural LLM may improve the accuracy of the third-party data.

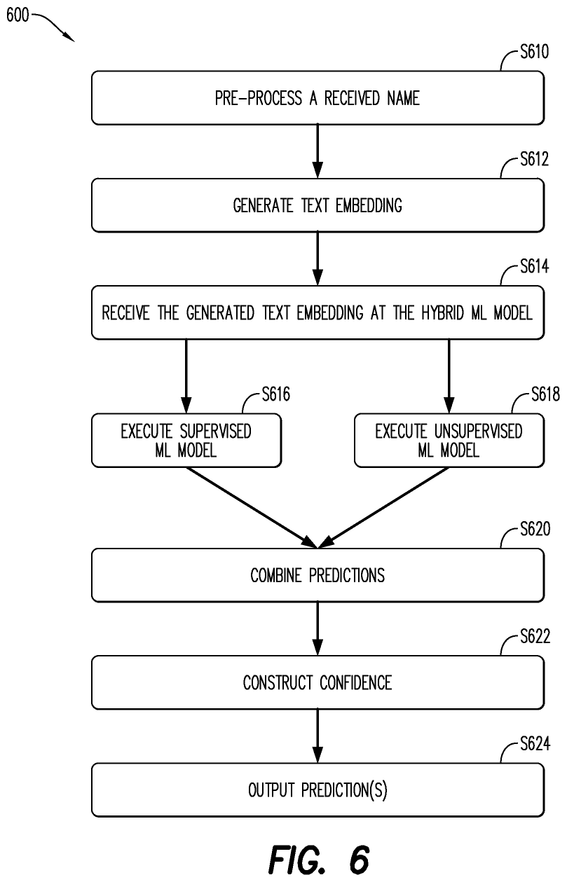

FIG. 6 illustrates a method 600 for executing trained hybrid machine learning model 107. Prior to the method 600, it is determined that the direct mapping status is that the direct mapping is absent and that the entity name is not a brand name.

In response to the absent direct mapping status and lack of brand name, the received name is pre-processed by the text pre-processing tool 151 at S610. The text pre-processing may be as described above. The pre-processed text is then received by a text embedding tool 152. The text embedding tool 152 generates a text embedding at S612, as described above. The generated text embedding is received at the hybrid ML model 107 at S614. Using the text embedding, the supervised ML model 154 is executed at S616. Using the text embedding, the unsupervised ML model 156 is executed at S618. It is noted that S616 and S618 may be executed at one of the same time, substantially the same time, at different times. In a case S616 and S618 are executed at different times, they may be executed in any order.

Execution of the supervised ML model 154 at S616 may occur as follows.

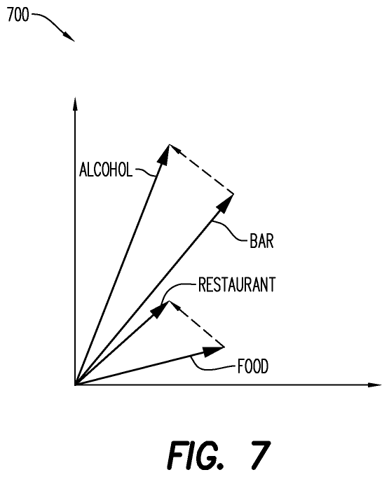

To classify a new data point (an unknown entity e.g., entity name), the supervised ML model 154 may first represent each data point (e.g., entity name) in the form of a multi-dimensional feature vector, with each dimension corresponding to a feature. The features may include the text embedding of words in the entity name and other third-party attributes. As a non-exhaustive example, the dimensional space may be a 300-dimensional space, with each dimensional space representing an embedded linguistic meaning of the word. The vectors may be projected into a 2-D plane using dimensionality reduction techniques such as Principal Component Analysis (PCA) or t-distributed stochastic neighbor embedding (TSNE). As a non-exhaustive example, FIG. 7 provides a non-exhaustive example of a projection 700. It is observed that the word “restaurant” is closer to “food” than “food” is to “bar”, as “restaurant” and “food” both relate to eating, but “bar” is not.

Then, the supervised ML model 154 may compute a distance between this data point and each of the other data points in the training dataset. The distance measurement may be Euclidean, Manhattan, or any other suitable distance metric. Pursuant to some embodiments, a cosine similarity distance metric is used. Once the distances are calculated, the supervised ML model 154 may select the “K” data points that are closest to the new data point.

As a non-exhaustive example, K=9, such that the supervised ML model 154 finds the 9 historical entities that are most similar to the new/input entity. Then the supervised ML model 154 classifies the new/input entity by majority voting. The new data point may be assigned the class code that has the highest representation among its 9 nearest neighbors. For example, if 5 out of 9 neighbors are “retail” entities, then the new entity may be assigned the class code for “retail”. It is noted that in case of a tie, the supervised ML model 154 may select the class code based on the closest instances among the neighbors or based on a tie-breaking rule previously set in the system.

KNN may easily adapt to different data distributions and may find complex decision boundaries, thus making it suitable for entity classification.

It is noted that KNN is also computationally intensive and may require distance calculations with all data points in the training set for each new classification. How computationally intensive KNN may be may also depend on the choice of “K”, the number of neighbors considered and the type of distance metric used.

The supervised machine learning (ML) model 154 may be trained with a dataset of 100,000 data points, or any suitable number of data points. Each data point in the dataset may represent a unique entity, with features extracted from its name and third party data attributes. It may be desirable to select enough points in the dataset for training to provide sufficient diversity and representation in the data. The large amount of data points may aid in improving the generalization capability of the model, allowing it to make accurate predictions for unseen instances. It is noted that increasing the dataset beyond this point may lead to diminishing returns as a larger dataset would significantly increase computational time during both training and testing phases without a corresponding substantial increase in accuracy.

The supervised ML model 154 may output a list of one or more predicted internal classification codes 110, in order of decreasing likelihood of the predicted internal class code being accurate. According to some embodiments, the list may include the most likely top three predicted internal classification codes.

Execution of the unsupervised ML model 156 at S618 may occur as follows.

The unsupervised machine learning (ML) model 156 may generate additional predicted internal class codes for the given entity name to supplement the output of the supervised ML model 154. It may be desirable to supplement the output of the supervised ML model 154, to provide a more comprehensive prediction set that may be less computationally expensive. It is noted that using the hybrid ML model 107 may provide for a more efficient system as the hybrid model reduces the expense of only using the supervised ML model 154 with a higher K value. The unsupervised ML model 156 may include, with respect to the training dataset, determining a projection, or centroid profile, that represents an internal classification code. The classification code prediction for the new data point is computed by calculating the distance of the embedded vectors in the new data point to all of the embedded vectors of the internal classification code centroids. The centroid which is closest to the entity's embedded vector is the predicted class code.

According to some embodiments, PredictedClassCode=min(d(X, Cᵢ)), i∈[0, 300], where d(X, Cᵢ) is the distance calculation from the entity's embedded vector X to each of the 300-internal classification code centroid C:

$$d ( X , {C}_{i} ) = \sqrt{{\sum }_{j = 0}^{300} {( {x}_{j} - {c}_{ij} )}^{2}}$$

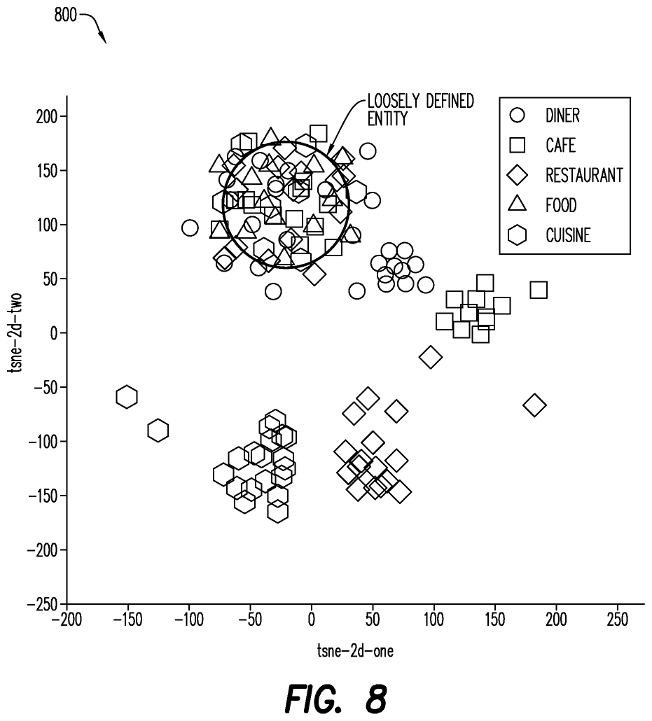

With respect to the training dataset, for each internal classification code, a centroid is created. The centroid is a representative list of keywords that are most representative of entities falling into that classification code. For example, for each internal classification code, the top twenty-five most common words from the training data that are mapped to that internal classification code are selected. As a non-exhaustive example, for a restaurant classification code, the keywords may include “restaurant,” “café,” “diner,” “food,” “cuisine,” etc. This representative list may be the “centroid” of the classification code. FIG. 8 provides a sample visualization of these centroids. Using TNSE, the data is visualized in the 2D map of FIG. 8. Entities with the same embedding attribute may form a cluster. Then, a centroid of an entity classification code may be constructed to represent the center of such cluster. Once the centroids are constructed, the word lists may be converted into their respective embedded representation using the pre-trained model of the text embedding tool. The centroid of a classification code may be a vector in the same semantic space as the new/input entity name.

Then, when a new entity name needs to be classified, the distance between the generated text embedding for the new data point (an unknown entity e.g., entity name) and the embeddings of the classified code centroids is determined. By determining the proximity of the input to the centroids, the unsupervised ML model 156 generates additional predicted internal classification codes 111, in order of decreasing likelihood of the predicted internal class code being accurate, with the closer (smaller) distances being more accurate.

The unsupervised ML model 156 may provide a broader range of classification code predictions (e.g., up to ten) while keeping computational costs lower, as compared to the supervised ML model 154. Additionally, using class code centroids, which may be representative of the commonalities within each class, the unsupervised ML model 156 may provide predictions that align well with the overall characteristics of the different entity categories.

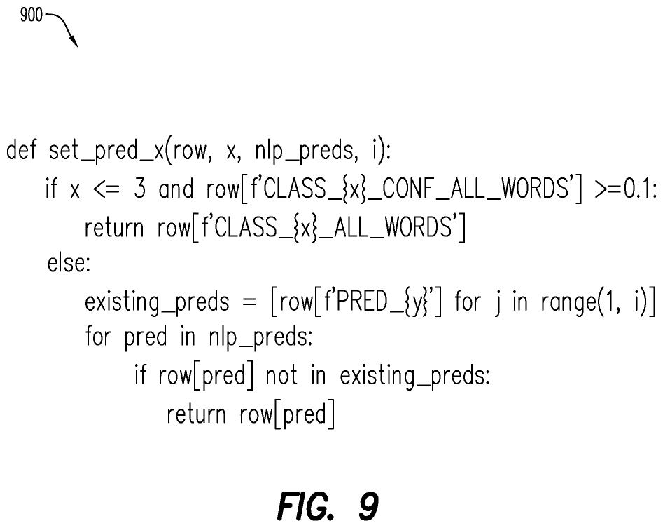

Turning back to the method 600, in S620 the classification code predictions 110 output from the supervised ML model 154 and the classification code predictions 111 output from the unsupervised ML model 156 are combined. It is noted that combining the output of both the supervised ML model 154 and the unsupervised ML model 156 takes advantage of the strengths of both methods while minimizing the weaknesses of just using the supervised ML model 154. As a non-exhaustive example, the top three classification code predictions 110 output from the supervised ML model 154 may be combined with the top four classification code predictions 111 output from the unsupervised ML model 156, resulting in the top seven predictions. FIG. 9 provides pseudocode 900 describing the process of selecting predictions. For the top three predictions (‘x<=3’), the pseudocode 900 directly returns a particular internal classification code in a case the confidence value (CLASS*CONF_ALL_WORDS) is equal to or greater than 0.1. For predictions from four onwards, the pseudocode 900 may initiate a check to avoid repetition of predictions. The check may include keeping track of existing predictions and then the code iterates through the unsupervised classification code predictions 111. If an unsupervised classification code prediction 111 has not yet been chosen (i.e., it is not in ‘existing_preds’), then that unsupervised classification code prediction 111 is selected for combination in S620. It is noted that the pseudocode 900 ensures the top three, in this case, predictions from the supervised ML model are selected first (provided they have sufficient confidence), and then the remaining slots are filled with unsupervised classification code predictions 111, thereby combining benefits from both ML models.

It is additionally noted that the hybrid ML model 107 accommodates the introduction of new internal classification codes with less reliance on large amounts of training data as compared to conventional supervised ML models. The hybrid ML model 107 is less dependent, as compared to conventional ML models, on the volume of data for each internal classification code, instead focusing on the semantic similarity of the entity descriptions to established internal classification codes. In a case a new internal classification code is introduced, embodiments provide for the integration of the internal classification code into the hybrid ML model 107 by aligning the code with the semantic space that has already been established. For example, the centroids of existing class codes, may be used, based on the most common words from the training data, to project the new internal classification code into this semantic space. This feature may provide for the hybrid ML model 107 to make predictions for the new internal classification code even with a small number of examples.

Again turning back to the method 200, in S622, confidence values are constructed for each of the supervised classification code predictions 110 and unsupervised classification code predictions 111 using the confidence tool 158, as described above.

The supervised ML model 154 may provide a probability of each prediction being accurate, and this probability may be used as the confidence value. The probability/confidence value for the supervised ML model 154 may be calculated by the confidence tool 158 as the number of neighbors that have a particular label, over the total number of neighbors, provided the confidence value adheres to the following conditions: confined to [0, 1], calculated for any possible class code, and sum equals to 1. Continuing with the above non-exhaustive example, K=9, so 9 neighbors were used, limiting the number of predictions output by the supervised ML model 154 to 9.

The unsupervised ML model 156 may not output probabilities like the supervised ML model 154. However, the confidence tool 158 may construct a confidence value using the cosine similarity value. Cosine similarity has a domain of [−1, 1], and if the two vectors form an acute angle, the domain will be [0, 1]. The confidence value may be calculated as =max(cosine similarity, 0). Based on this, in a case the predicted classification vector is not even in the same direction as the text embedding vector of the centroid, the confidence is set to 0. Otherwise, the cosine similarity-based confidence value is used.

Then, in embodiments, the confidence tool 158 lists the top nine, in this example, confidence values in decreasing order (most to least confident). Next, the confidence tool 158 calibrates the confidence scores. The calibration may include, for the top three confidence values, applying a 50% weight to KNN confidence values and a 50% weight to cosine similarity-based confidence values. For confidence values for predictions four through nine, the calculated confidence value is used at full weight.

Following the confidence score construction, the predicted one or more internal classification codes are output in S624. The output may include one or more predicted internal classification codes with the highest confidence values.

Pursuant to some embodiments, the hybrid ML model 107 may be back-tested to validate the performance of the model using data that it has not encountered during the training phase. As a non-exhaustive example, the hybrid ML model 107 was trained with a dataset comprising 100,000 samples. Then, to counterbalance any overfitting or biases that could have been introduced during training, the model was back-tested using a much larger dataset, comprising 11 million samples. The hybrid ML model 107 may be further validated by users with expert knowledge.

The embodiments described herein may be implemented using any number of different hardware configurations. For example, FIG. 10 illustrates an apparatus 1000 that may be, for example, associated with the system 100 described with respect to FIG. 1. The apparatus 1000 comprises a processor 1010, such as one or more commercially available Central Processing Units (“CPUs”) in the form of one-chip microprocessors, coupled to a communication device 1020 configured to communicate via a communication network (not shown in FIG. 10). The communication device 1020 may be used to communicate, for example, with one or more remote third-party business or economic platforms, administrator computers, insurance agent, and/or communication devices (e.g., PCs and smartphones). Note that communications exchanged via the communication device 1020 may utilize security features, such as those between a public internet user and an internal network of an insurance company and/or an enterprise. The security features might be associated with, for example, web servers, firewalls, and/or PCI infrastructure. The apparatus 1000 further includes an input device 1040 (e.g., a mouse and/or keyboard to enter information about data sources, research data, state data, release dates, etc.) and an output device 1050 (e.g., to output reports regarding predictions, status, alerts, etc.).

The processor 1010 also communicates with a storage device 1030. The storage device 1030 may comprise any appropriate information storage device, including combinations of magnetic storage devices (e.g., a hard disk drive), optical storage devices, mobile telephones, and/or semiconductor memory devices. The storage device 1030 stores a program 1015 and/or an application for controlling the processor 1010. The processor 1010 performs instructions of the program 1015, and thereby operates in accordance with any of the embodiments described herein. For example, the processor 1010 may a receive a request for assignment of an internal classification code for an entity name and retrieve third party data related to the entity name. The processor 1010 may then automatically generate a predicted internal classification code based on the received and retrieved data.

The program 1015 may be stored in a compressed, uncompiled and/or encrypted format. The program 1015 may furthermore include other program elements, such as an operating system, a database management system, and/or device drivers used by the processor 1010 to interface with peripheral devices.

As used herein, information may be “received” by or “transmitted” to, for example: (i) the apparatus 1000 from another device; or (ii) a software application or module within the apparatus 1000 from another software application, module, or any other source.

In some embodiments (such as shown in FIG. 10), the storage device 1030 further includes a classification data store 104 and a risk relationship data store 118.

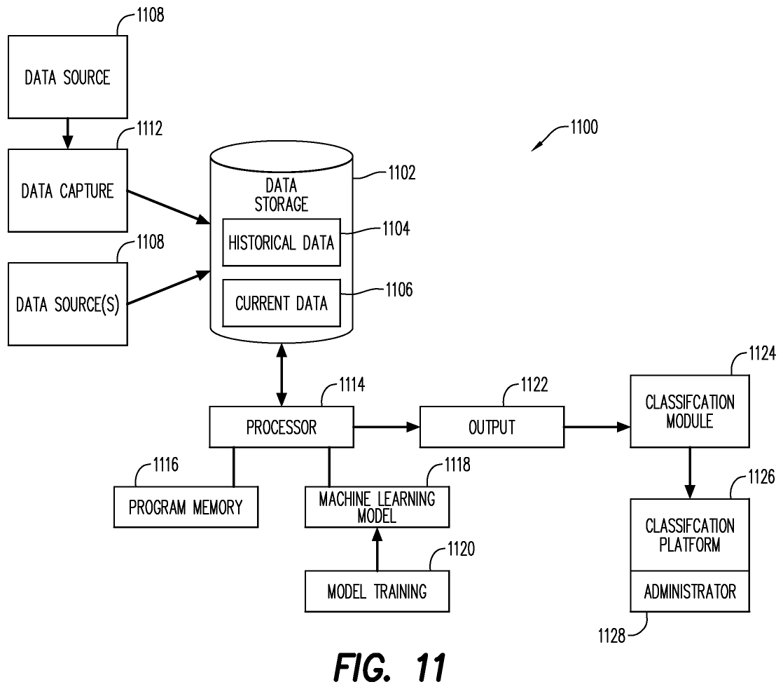

According to some embodiments, one or more machine learning algorithms and/or predictive models may be used to perform automatic internal classification code prediction/generation, and re-generation. Features of some embodiments associated with a model will now be described by referring to FIG. 11. FIG. 11 is a partially functional block diagram that illustrates aspects of a computer system 1100 provided in accordance with some embodiments of the invention. For present purposes it will be assumed that the computer system 1100 is operated by an insurance company (not separately shown) for the purpose of supporting automated internal classification code generation/prediction for an entity operation based on an entity name (e.g., to manage tasks in a workflow). According to some embodiments, the third-party data and/or risk relationship data may also be used to supplement and leverage the computer system 1100.

The computer system 1100 includes a data storage module 1102. In terms of its hardware the data storage module 1102 may be conventional, and may be composed, for example, by one or more magnetic hard disk drives. A function performed by the data storage module 1102 in the computer system 1100 is to receive, store and provide access to both historical data 1104 and current data 1106. As described in more detail below, the historical data 1104 is employed to train a machine learning model to provide an output that indicates an identified performance metric and/or an algorithm to generate an internal classification code, and the current data 1106 is thereafter analyzed by the model. Moreover, as time goes by, and results become known from processing entity names/operations assigned to current internal classification codes, at least some of the current decisions may be used to perform further training of the model. Consequently, the model may thereby adapt itself to changing conditions.

Either the historical data 1104 and/or the current data 1106 may include, according to some embodiments, descriptions of entity operations etc. The data may come from one or more data sources 1108 that are included in the computer system 1100 and are coupled to the data storage module 1102. Non-exhaustive examples of data sources may be an insurance company's policy database (not separately indicated), state DOI databases, etc. It is noted that the data may originate from data sources whereby the data may be extracted from raw files or the like by one or more data capture modules 1112. The data capture module(s) 1112 may be included in the computer system 1100 and coupled directly or indirectly to the data storage module 1102. Examples of the data source(s) 1108 that may be captured by a data capture model 1112 include data storage facilities for big data streams, document images, text files, and web pages (e.g., DOI webpages). Examples of the data capture module(s) 1112 may include one or more optical character readers, a speech recognition device (i.e., speech-to-text conversion), a computer or computers programmed to perform NLP, a computer or computers programmed to identify and extract information from images or video, a computer or computers programmed to detect key words in text files, and a computer or computers programmed to detect indeterminate data regarding an employee such as a questionnaire response, etc.

The computer system 1100 also may include a computer processor 1114. The computer processor 1114 may include one or more conventional microprocessors and may operate to execute programmed instructions to provide functionality as described herein. Among other functions, the computer processor 1114 may store and retrieve historical insurance data and timelines 1104 and current data 1106 in and from the data storage module 1102. Thus, the computer processor 1114 may be coupled to the data storage module 1102.

The computer system 1100 may further include a program memory 1116 that is coupled to the computer processor 1114. The program memory 1116 may include one or more fixed storage devices, such as one or more hard disk drives, and one or more volatile storage devices, such as RAM devices. The program memory 1116 may be at least partially integrated with the data storage module 1102. The program memory 1116 may store one or more application programs, an operating system, device drivers, etc., all of which may contain program instruction steps for execution by the computer processor 1114.

The computer system 1100 further includes a machine learning model component 1118. In certain practical embodiments of the computer system 1100, the machine learning model component 1118 may effectively be implemented via the computer processor 1114, one or more application programs stored in the program memory 1116, and computer stored as a result of training operations based on the historical data 1104 (and possibly also data received from a third party). In some embodiments, data arising from model training may be stored in the data storage module 1102, or in a separate computer store (not separately shown). A function of the machine learning model component 1118 may be to generate an internal classification code for an entity's operations based on the entity name, etc. The machine learning model component may be directly or indirectly coupled to the data storage module 1102.

The machine learning model component 1118 may operate generally in accordance with conventional principles for machine learning models, except, as noted herein, for at least some of the types of data to which the machine learning model component is applied. Those who are skilled in the art are generally familiar with programming of predictive/machine learning models. It is within the abilities of those who are skilled in the art, if guided by the teachings of this disclosure, to program a predictive/machine learning model to operate as described herein.

Still further, the computer system 1100 includes a model training component 1120. The model training component 1120 may be coupled to the computer processor 1114 (directly or indirectly) and may have the function of training the machine learning model component 1118 based on the historical data 1104 and/or information about entities. (As will be understood from previous discussion, the model training component 1120 may further train the machine learning model component 1118 as further relevant data becomes available.) The model training component 1120 may be embodied at least in part by the computer processor 1114 and one or more application programs stored in the program memory 1116. Thus, the training of the machine learning model component 1118 by the model training component 1120 may occur in accordance with program instructions stored in the program memory 1116 and executed by the computer processor 1114.

In addition, the computer system 1100 may include an output device 1122. The output device 1122 may be coupled to the computer processor 1114. A function of the output device 1122 may be to provide an output that is indicative of (as determined by the trained machine learning model component 1118) particular internal classification codes for entity operations based on an entity name, etc. The output may be generated by the computer processor 1114 in accordance with program instructions stored in the program memory 1116 and executed by the computer processor 1114. More specifically, the output may be generated by the computer processor 1114 in response to applying the data for the current simulation to the trained machine learning model component 1118. The output may, for example, be a defined classification code, description, confidence value, etc. In some embodiments, the output device may be implemented by a suitable program or program module executed by the computer processor 1114 in response to operation of the machine learning model component 1118.

Still further, the computer system 1100 may include a classification module 1124. The classification module 1124 may be implemented in some embodiments by a software module executed by the computer processor 1114. The classification module 1124 may have the function of rendering a portion of the display on the output device 1122. Thus, classification module 1124 may be coupled, at least functionally, to the output device 1122. In some embodiments, for example, the classification module 1124 may direct communications with an enterprise by referring to an administrator 1128 via a classification platform 1126, messages customized and/or generated by the machine learning model component 1118 (e.g., indicating internal classification code assignments, confidence values, etc.) and found to be associated with various parties or types of parties.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, external drive, semiconductor memory such as read-only memory (ROM), random-access memory (RAM), and/or any other non-transitory transmitting and/or receiving medium such as the Internet, cloud storage, the Internet of Things (IoT), or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

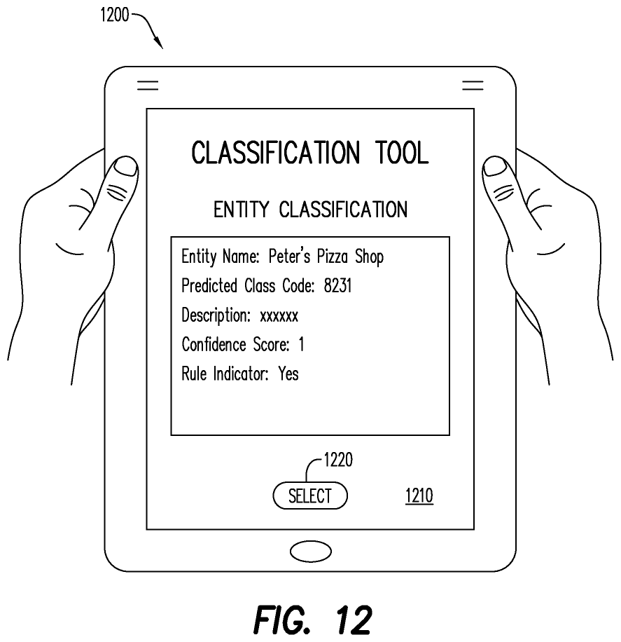

Although specific hardware and data configurations have been described herein, note that any number of other configurations may be provided in accordance with embodiments of the present invention (e.g., some of the information associated with the displays described herein may be implemented as a virtual or augmented reality display and/or the database described herein may be combined or stored in external systems.) Moreover, although embodiments have been described with respect to particular types of enterprises (e.g., an insurance company), embodiments may instead be associated with other types of businesses in addition to and/or instead of those described herein (e.g., financial institutions, universities, governmental departments, etc.). Similarly, although certain attributes were described in connection with some embodiments herein, other types of attributes may be used instead. Sill further, the displays and devices illustrated herein are only provided as examples and embodiments may be associated with any other types of user interfaces. For example, FIG. 12 illustrates a handheld tablet computer 1200 showing an Entity Classification display 1210 according to some embodiments. The Entity Classification display 1210 may include a predicted class code that can be selected and/or modified by a user of the handheld computer 1200 (e.g., via a “Select” icon 1220) to open the item to see more details. The Entity Classification display 1210 may allow a user to see which internal class codes are predicted for a particular entity's operations based on the entity name and a confidence of the model in predicting that class code. This may help users focus on obtaining the appropriate additional information and/or analysis that is based on a particular internal classification code.

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

What is claimed is:

1. A system implemented via a back-end application computer server comprising:
a classification data store that contains electronic records associated with entity classifications; and
the back-end application computer server, coupled to the classification data store, including:
a computer processor; and
a memory coupled to the computer processor and storing instructions that, when executed by the computer processor, cause the back-end application computer server to:
receive a name and an address associated with the name;
receive third-party data associated with the name;
classify the name as an enterprise type using a classification tool and the third-party data, the classification tool including a trained hybrid machine learning (ML) model;
a communication port coupled to the back-end application computer server to facilitate an exchange of data with a remote device via a distributed communication network to support interactive user interface displays that include information about the classification.

2. The system of claim 1, wherein the third-party data is received using the name and the address.

3. The system of claim 2, wherein the third-party data includes a plurality of Standard Industry Classification (SIC) codes and a plurality of North American Industry Classification System (NAICS) codes.

4. The system of claim 3, wherein classification further comprises instructions to cause the back-end application computer server to:
determine the name maps to at least one of the SIC code and the NAICS code;
identify an internal classification code mapped to the at least one SIC code and NAICS code mapped to the name; and
assign the internal classification code to the name.

5. The system of claim 3, wherein classification further comprises instructions to cause the back-end application computer server to:
determine the name does not map to at least one of the SIC code and the NAICS code; and
execute the trained hybrid ML model using the name as input.

6. The system of claim 5, wherein execution of the trained hybrid ML model further comprises instructions to cause the back-end application computer server to:
execute a K-Nearest Neighbors (KNN) classifier using the name, wherein execution of the KNN classifier outputs at least one internal classification code as KNN classification output for the name;
execute an unsupervised labelling classifier using the name, wherein execution of the unsupervised labelling classifier outputs at least on internal classification code as unsupervised classification output for the name;
select at least one KNN classifier output and at least one unsupervised labelling classifier output; and
determine a confidence score for each selected KNN classifier output and unsupervised labelling classifier output.

7. The system of claim 6, wherein execution of the KNN classifier outputs three internal classification codes for the name.

8. The system of claim 6, wherein execution of the unsupervised labelling classifier further comprises instructions to cause the back-end application computer server to:
compare the name to a plurality of class centroids for each internal classification code.

9. The system of claim 8, wherein each class centroid includes a plurality of key words representing the enterprise type.

10. The system of claim 9, wherein the comparison further comprises instructions that cause the back-end application computer server to:
convert each key word of the centroid to a centroid vector;
convert the name to a name vector;
determine a proximity of the name vector to each centroid vector; and
output at least one internal classification code for the name as the unsupervised classification output, wherein the output internal classification code is mapped to the smallest determined proximity.

11. The system of claim 6, wherein the confidence score indicates the confidence the trained hybrid ML model has that the output internal classification code is accurate.

12. A method implemented via a back-end application computer server of an enterprise, comprising:
receiving a name and an address associated with the name;
receiving third-party data associated with the name;
classifying the name as an enterprise type using a classification tool and the third-party data, the classification tool including a trained hybrid machine learning (ML) model;
transmitting the classified enterprise type to a user and a client system; and
displaying the classified enterprise type on a user interface display.

13. The method of claim 12, wherein the third-party data includes a plurality of Standard Industry Classification (SIC) codes and a plurality of North American Industry Classification System (NAICS) codes.

14. The method of claim 13, wherein classification further comprises:
determining the name maps to at least one of the SIC code and the NAICS code;
identifying an internal classification code mapped to the at least one SIC code and NAICS code mapped to the name; and
assigning the internal classification code to the name.

15. The method of claim 13, wherein classification further comprises:
determining the name does not map to at least one of the SIC code and the NAICS code; and
executing the trained hybrid ML model using the name as input.

16. The method of claim 15, wherein execution of the trained hybrid ML model further comprises:
executing a K-Nearest Neighbors (KNN) classifier using the name, wherein execution of the KNN classifier outputs at least one internal classification code as a KNN classification output for the name;
executing an unsupervised labelling classifier using the name, wherein execution of the unsupervised labelling classifier outputs at least on internal classification code as an unsupervised classifier output for the name;
selecting at least one KNN classifier output and at least one unsupervised labelling classifier output; and
determining a confidence score for each selected KNN classifier output and unsupervised labelling classifier output.

17. The method of claim 12, further comprising:
pre-filling an entry field on a client system user interface with the classified enterprise type, wherein pre-filling is based on a confidence value for the classified enterprise type.

18. A non-transitory, computer-readable medium storing instructions that, when executed by a processor, cause the processor to perform a method implemented via a back-end application computer server of an enterprise, the method comprising:
receiving a name and an address associated with the name;
receiving third-party data associated with the name;
classifying the name as an enterprise type using a classification tool and the third-party data, the classification tool including a trained hybrid machine learning (ML) model;
transmitting the classified enterprise type to a user and a client system; and
displaying the classified enterprise type on a user interface display.

19. The medium of claim 18, wherein classification further comprises:
determining the name maps to at least one of a Standard Industry Classification (SIC) code and a North American Industry Classification System (NAICS) code included in the third-party data;
identifying an internal classification code mapped to the at least one SIC code and NAICS code mapped to the name; and
assigning the internal classification code to the name.

20. The medium of claim 19, wherein classification further comprises:
determining the name does not map to at least one of the SIC code and the NAICS code; and
executing the trained hybrid ML model using the name as input, wherein execution further comprises:
executing a K-Nearest Neighbors (KNN) classifier using the name, wherein execution of the KNN classifier outputs at least one internal classification code as a KNN classifier output for the name;
executing an unsupervised labelling classifier using the name, wherein execution of the unsupervised labelling classifier outputs at least on internal classification code as an unsupervised classifier output for the name;
selecting at least one KNN classifier output and at least one unsupervised labelling classifier output; and
determining a confidence score for each selected KNN classifier output and unsupervised labelling classifier output.
